(19) United States
(12) Patent Application Publication
(10) Pub. No.: US 2018/0339886 A1
(43) Pub. Date: Nov. 29, 2018

(54) SYSTEM FOR CONTROLLING TRANSPORT OF LIQUID TANK BY OVERHEAD CRANE, AND METHOD FOR TRANSPORTING LIQUID TANK BY OVERHEAD CRANE

(71) Applicants: SINTOKOGIO, LTD., Aichi (JP); NATIONAL INSTITUTE OF TECHNOLOGY, Tokyo (JP)

(72) Inventors: Kunihiro HASHIMOTO, Aichi (JP); Makio SUZUKI, Aichi (JP); Akihiro KANESHIGE, Aichi (JP); Satoshi UEKI, Aichi (JP); Yu YAMAUCHI, Aichi (JP)

(73) Assignees: SINTOKOGIO, LTD., Aichi (JP); NATIONAL INSTITUTE OF TECHNOLOGY, Tokyo (JP)

(21) Appl. No.: 15/771,360

(22) PCT Filed: Apr. 7, 2017
(86) PCT No.: PCT/JP2017/014484

§ 371 Date: Apr. 26, 2018

(30) Foreign Application Priority Data
May 18, 2016 (JP) 2016-099514

(51) Int. Cl. B66C 1/02

(52) U.S. Cl. CPC B66C 1/0262

(57) ABSTRACT

A system for controlling transport of a liquid tank by an overhead crane and a method for transporting the liquid tank by the overhead crane, which can suppress sloshing of liquid in the tank, are provided. In the control of the overhead crane cart, the swing of a liquid tank and a suspender (16) that suspends the liquid tank from an overhead crane cart (14), and the sloshing of liquid in the liquid tank are modeled into a coupled system model, and the system is designed based on a mixed H₂/H_{∞} control. method in which feedback control is executed using a swing angle (θ) of the suspender, a traveling command value of the overhead crane cart and an external force acting on the liquid tank are external inputs, and a difference (z) between a position of the overhead crane cart and a position of the liquid tank is the control amount, wherein an integrator or a low pass filter is used as a frequency weight function (W₂) of H₂ control, and wherein a frequency weight function (W₂₈ ) of H_{∞} control is designed to cover a multiplicative error between the coupled system model, and a nominal model in which the sloshing of the liquid in the liquid tank is not taken into consideration.

### TECHNICAL FIELD

The present invention relates to a system for controlling transport of a liquid tank, i.e., a tank containing liquid, by an overhead crane, and a method for transporting the liquid tank by the overhead crane. The present invention particularly relates to a system for controlling transport of a liquid tank and a method for transporting the liquid tank, which increase the transport efficiency and the safety in transporting the liquid tank.

### BACKGROUND ART

In foundries, molten metal with high temperature melted in a melting furnace is poured into a mold using a pouring machine. The foundry is built in a vast area, and the pouring machine is usually set away from the melting furnace and the like. In the foundry, a molding machine for fabricating the molds, a line where the molds fabricated by the molding machine are transported to the pouring machine, a line where the molds to which the molten metal is poured by the pouring machine are cooled, and the like are installed, and thus it is often difficult to secure a line where the molten metal is transported from the melting furnace to the pouring machine. In view of this, the molten metal is taken in a ladle and the ladle is transported by an overhead crane.

The ladle containing the molten metal is heavy, and the molten metal contained in the ladle has high temperature. If the ladle swings largely, it is dangerous and in addition, it takes time until the swing stops. Moreover, if the molten metal in the ladle overflows, it may cause a serious accident. If the ladle and a suspender used by the overhead crane to suspend the ladle swing together, the molten metal sticks to the wall surface of the ladle due to the centrifugal force generated by the swing of the suspender. In this case, apparent sloshing of the liquid surface does not easily occur. However, when the travel of the overhead crane is stopped or its travel velocity is changed, the suspender and the ladle swing. In this case, since it takes time until this swing stops, the work efficiency deteriorates. If the overhead crane travels at a frequency different from a cycle value (frequency) at which the suspender swings or if the suspender and the ladle are fixed so as not to swing relative to the overhead crane, the molten metal in the ladle sloshes and possibly overflows. To prevent the overhead crane from vibrating, a vibration suppression method for the overhead crane based on the velocity feedback control has been suggested (Patent Literature 1).

The overhead crane is often operated from an operator room and the like, which are separated away from the dangerous overhead crane. Thus a method has been suggested to control the overhead crane smoothly by improving operation tools (Patent Literature 2).

In the vibration suppression method for the overhead crane according to Patent Literature 1, however, a suspended load is assumed as a rigid body and the vibration of the molten metal contained in the ladle, i.e., the sloshing is not taken into consideration.

The operation tool according to Patent Literature 2 enables single operator to perform the remote operation without a mistake but this literature does not describe the fast transport to the target area with the overhead crane without a swing.

In view of this, it is an object of the present invention to provide a system for controlling transport of a liquid tank by an overhead crane and a method for transporting the liquid tank by the overhead crane, which can suppress swing of the liquid tank and sloshing of the liquid in the tank. Moreover, it is an object of the present invention to provide a system for controlling transport of the liquid tank by the overhead crane and a method for transporting the liquid tank by the overhead crane, which can transport the liquid tank to the target area faster by using the overhead crane through a remote operation.

### PRIOR-ART PUBLICATION

### Patent Literature

### Patent Literature 1

Japanese Patent Laid-Open Publication No. H6-336394

### Patent Literature 2

Japanese Patent Laid-Open Publication No. H9-104587

### SUMMARY OF INVENTION

A system for controlling transport according to a first aspect of the present invention for achieving the above object is a system for controlling transport of a liquid tank 30 by an overhead crane 10 as in FIGS. 1 to 3, for example, wherein: a swing of the liquid tank 30 and a suspender 16 that suspends the liquid tank 30 from an overhead crane cart 14, and a sloshing of liquid 34 in the liquid tank 30 are modeled into a coupled system model; the system is designed based on a mixed H₂/H_{∞}control method in which feedback control is executed using a swing angle θ of the suspender 16, a traveling command value w_{∞} of the overhead crane cart 14 and an external force W₂ acting on the liquid tank 30 are external inputs, and a difference z between a position of the overhead crane cart 14 and a position of the liquid tank 30 is a control amount, wherein an integrator or a low pass filter is used as a frequency weight function W₂ of H₂ control, and wherein a frequency weight function W_{∞} of H_{∞} control is designed to cover a multiplicative error between the coupled system model and a nominal model in which the sloshing of the liquid 34 in the liquid tank 30 is not taken into consideration; and the overhead crane cart 14 is controlled so as to suppress the swing of the liquid tank 30 when the liquid tank 30 is transported by the overhead crane 10.

With such a structure, the overhead crane cart can be controlled to suppress the swing of the liquid tank and the sloshing of the liquid in the liquid tank, i.e., the sloshing of the liquid surface can be suppressed. Accordingly, the liquid tank can reach the target area fast and the work efficiency can he increased.

A system for controlling transport of a second aspect of the present invention is the system for controlling the transport of the first aspect, wherein the system is designed as illustrated in FIG. 2, for example, so that a primary vibration mode 36 of liquid 34 in the liquid tank 30 is controlled. With such a structure, the primary vibration mode of the liquid in the liquid tank suppressed, and therefore the high-order vibration does not occur and the liquid does not overflow. Thus, the desired object can be achieved.

A system for controlling transport of a third aspect of the present invention is the system for controlling the transport of the first or second aspect, wherein the traveling command value w_{∞} of the overhead crane cart 14 is a velocity command value of the overhead crane cart 14 and is input by manipulating the angle of a paddle 110, and a force to change the angle is generated in the paddle 110 on the basis of the swing of the liquid tank 30 as illustrated in FIGS. 1 to 3, for example. With such a structure, the information as to whether the operator should accelerate or decelerate is transmitted to the operator through the paddle. This enables the operator to surely transport the liquid tank by the overhead crane even through the remote operation. Accordingly, the liquid tank can reach the target area fast.

A system for controlling transport of a fourth aspect of the present invention is the system for controlling the transport of any of the first to third aspects, wherein a delay in signal transmission between the overhead crane 10 and the paddle 110 is processed by scattering conversion as illustrated in FIG. 1 and FIG. 6, for example. Since the delay in signal transmission can be processed by the scattering conversion in this structure, the overhead crane cart can be operated stably even from the place away from the overhead crane.

In a method for transporting the liquid tank by the overhead crane of a fifth aspect of the present invention to achieve the above object, the liquid tank is transported by the overhead crane using the system for controlling the transport of any of the first to fourth aspects. With such a structure, the liquid tank can be transported by the overhead crane while the overhead crane cart is controlled to suppress the swing of the liquid tank and the sloshing of the liquid in the liquid tank.

A method for transporting the liquid tank by the overhead crane of a sixth aspect of the present invention is the method for transporting the liquid tank by the overhead crane of the fifth aspect, wherein the liquid tank 30 is a ladle which contains molten metal. With such a structure, the ladle can be transported by the overhead crane while the overhead crane cart is controlled to suppress the swing of the ladle and the sloshing of the molten metal in the ladle. Thus, the molten metal can be transported efficiently and safely in the foundry.

A system for controlling the transport of the present invention is a system for controlling the transport of a liquid tank by an overhead crane, wherein: the swing of a liquid tank and a suspender that suspends the liquid tank from an overhead crane cart, and the sloshing of liquid in the liquid tank are modeled into a coupled system model; the system is designed based on a mixed H₂/H_{∞} control method in which feedback control is executed using the swing angle of the suspender, a traveling command value of the overhead crane cart and an external force acting on the liquid tank are inputs, and a difference between a position of the overhead crane cart and a position of the liquid tank is a control amount, wherein an integrator or a low pass filter is used as a frequency weight function of H₂ control, and wherein a frequency weight function of H_{∞} control is designed to cover a multiplicative error between the coupled system model and a nominal model in which the sloshing of the liquid in the liquid tank is not taken into consideration; and the overhead crane cart is controlled so as to suppress the swing of the liquid tank when the liquid tank is transported by the overhead crane. Thus, the swing of the liquid tank and the sloshing of the liquid in the liquid tank can be suppressed, and the liquid tank can reach the target area fast and the work efficiency can be increased.

With the method for transporting the liquid tank by the overhead crane according to the present invention, the liquid tank can be transported by the overhead crane while the overhead crane cart is controlled so as to suppress the swing of the liquid tank and the sloshing of the liquid in the liquid tank.

The basic Japanese patent application, No. 2016-099514, filed May 18, 2016, is hereby incorporated by reference in its entirety in the present application.

The present invention will become more fully understood from the detailed description given below. However, the detailed description and the specific embodiments are only illustrations of the desired embodiments of the present invention, and so are given only for an explanation. Various possible changes and modifications will be apparent to those of ordinary skill in the art on the basis of the detailed description.

The applicant has no intention to dedicate to the public any disclosed embodiment. Among the disclosed changes and modifications, those which may not literally fall within the scope of the present claims constitute, therefore, a part of the present invention in the sense of the doctrine of equivalents.

The use of the articles “a,” “an,” and “the” and similar referents in the specification and claims are to be construed to cover both the singular and the plural form of a noun, unless otherwise indicated herein or clearly contradicted by the context. The use of any and all examples, or exemplary language (e.g., “such as”) provided herein is intended merely to better illuminate the invention, and so does not limit the scope of the invention, unless otherwise stated.

### BRIEF DESCRIPTION OF DRAWINGS

FIG. 1 is a schematic diagram for describing a structure for transporting a liquid tank by an overhead crane through a remote operation.

FIG. 2 is an explanatory diagram illustrating a structure for deriving a mathematical model from the structure of FIG. 1.

FIG. 3 is a block diagram of a generalized plant.

FIG. 4 is a Bode diagram showing one example of a frequency weight function W_{∞}.

FIG. 5 is a block diagram of a system for controlling the transport of a liquid tank by inputting a traveling command value of the overhead crane.

FIG. 6 is a block diagram of the system for controlling the transport of the liquid tank by inputting the travel of the overhead crane in view of the communication delay.

FIG. 7 is a Bode diagram showing the frequency weight function W_{∞} employed in Example 1.

FIG. 8 is a diagram showing the traveling velocity of the overhead crane cart in Example 1.

FIG. 9 are graphs showing the effect of the controls executed in a case 1 according to Example 1: FIG. 9(a) show the traveling velocity of the overhead crane cart in which the clear trapezoid with the larger values represents the input command value and the values below the trapezoid represent the actual traveling velocity, FIG. 9(b) show the swing angle of the liquid tank, and FIG. 9(c) show the sloshing of the liquid, and the control is executed in (a1), (b1) and (c1) and the control is not executed in (a2), (b2) and (c2).

FIG. 10 are graphs showing the effects of the controls executed in a case 2 according to Example 1: FIGS. 10(a) show the traveling velocity of the overhead crane cart in which the clear trapezoid with the larger values represents the input command value and the values below the trapezoid represents the actual traveling velocity, FIGS. 10(b) show the swing angle of the liquid tank, and FIG. 10(c) show the sloshing of the liquid, and the control is executed in (a1), (b1) and (c1) and the control is not executed in (a2), (b2) and (c2).

FIG. 11 show the graph representing the measurement results in Example 2: FIG. 11(a) shows the input angle of a paddle, FIG. 11(b) shows the cart velocity, FIG. 11(c) shows the cart position, FIG. 11(d) shows the swing angle, and FIG. 11(e) shows the sloshing of the liquid.

### MODE FOR CARRYING OUT THE INVENTION

An embodiment of the present invention will hereinafter be described with reference to the drawings. Throughout the drawings, the same or corresponding device is denoted by the same reference sign and the description to such a device is not repeated.

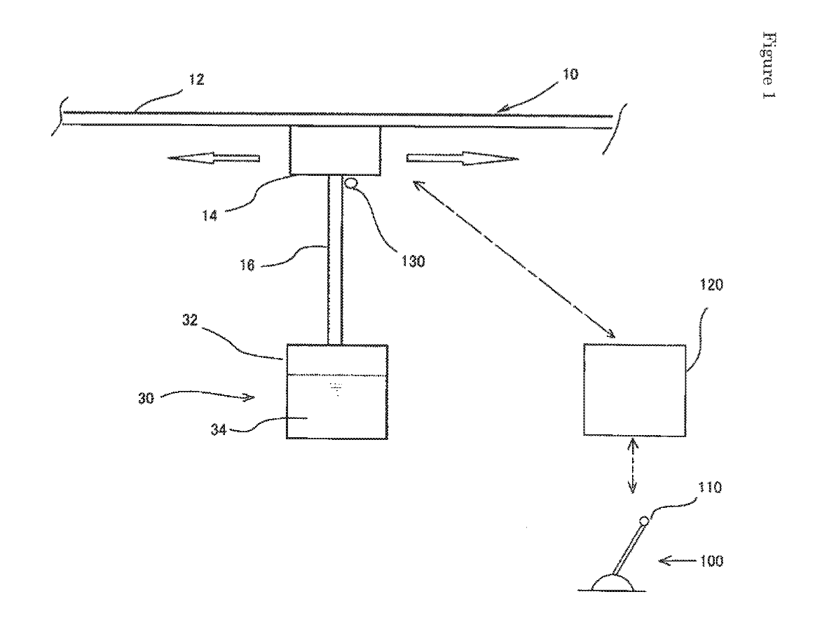

FIG. 1 is a schematic diagram for illustrating an apparatus for transporting a liquid tank 30 by an overhead crane 10 through a remote operation. The overhead crane 10 includes a rad 12 and the overhead crane cart 14 running on the rail 12, which are built in the upper part of a facility such as the foundry. The overhead crane 10 is a known apparatus and the detailed description thereto is omitted. The suspender 16 hangs down from the overhead crane cart 14, and suspends the liquid tank 30. The suspender 16 is a rod in this embodiment but a structure thereof is not particularly limited.

The liquid tank 30 is a container 32 which contains the liquid 34 and is transported by the overhead crane 10, and corresponds to, for example, a ladle which contains molten metal. The container 32 has an arbitrary shape such as a rectangular parallelepiped shape or a cylindrical shape. The liquid to be contained in the liquid tank 30 is not limited to the molten metal and may be water or other liquid.

In this embodiment, the suspender 16 is a rod and has high bending rigidity. Thus, the suspender 16 and the overhead crane cart 14 are connected together with the pin joint (rotatably connected). In the case where the liquid tank 30 is heavy like the ladle containing the molten metal, if the suspender 16 and the overhead crane cart 14 are connected together with the rigid joint, they are influenced by the large moment and easily destroyed; in this case, the durable structure is necessary. Thus the connection preferably employs the pin joint. In addition, an angular displacement meter 130 that measures the swing angle θ of the suspender 16 is provided.

An input device 100 changes the velocity command value for the overhead crane cart 14 in accordance with the tilt angle of the paddle 110. Here, the velocity command value is a value the operator inputs through the input device 100, and with this value, the operator commands the traveling velocity of the overhead crane cart 14. Note that the operator may input an acceleration command value or a position command value instead of the velocity command value through the input device 100. A control device 120 calculates the velocity command value on the basis of the tilt angle of the paddle 110 and sends the signal to the overhead crane cart 14. Note that the transport control system is incorporated in the control device 120 and/or the overhead crane 10. As described below, the signal may be sent from the control device 120 to the input device 100 in accordance with the output from the transport control system.

In the foundry, the input device 100 and the control device 120 are usually placed in the operation room. Therefore, the input device 100 and the control device 120 are placed away from the overhead crane 10 and the liquid tank 30, and the overhead crane 10 and the liquid tank 30 are operated remotely. In the operation room, that is, near the input device 100, a monitor (not shown) to display the motion of the overhead crane 10 or the liquid tank 30 may be disposed, for example. If the input device 100 or the control device 120 is very distant from the overhead crane 10 or the liquid tank 30, the communication therebetween may be carried out based on the wireless channel or the wired channel such as the Ethernet.

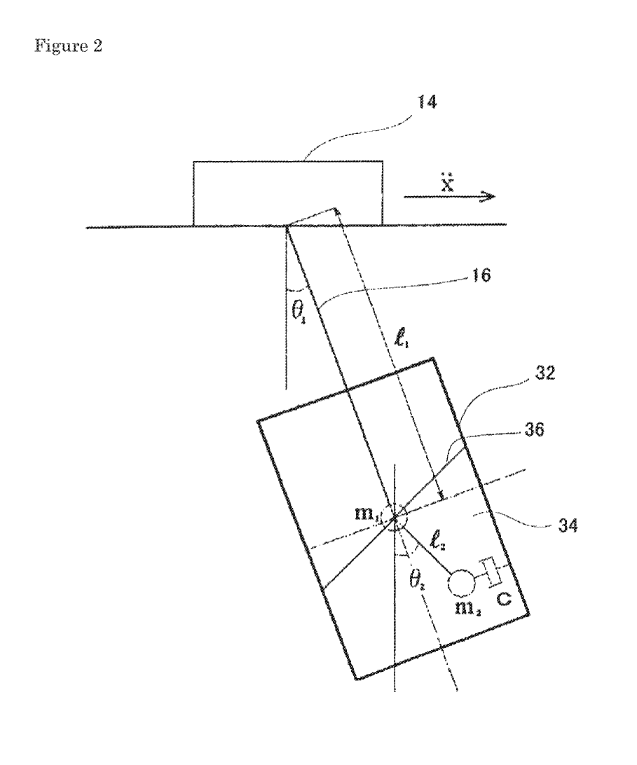

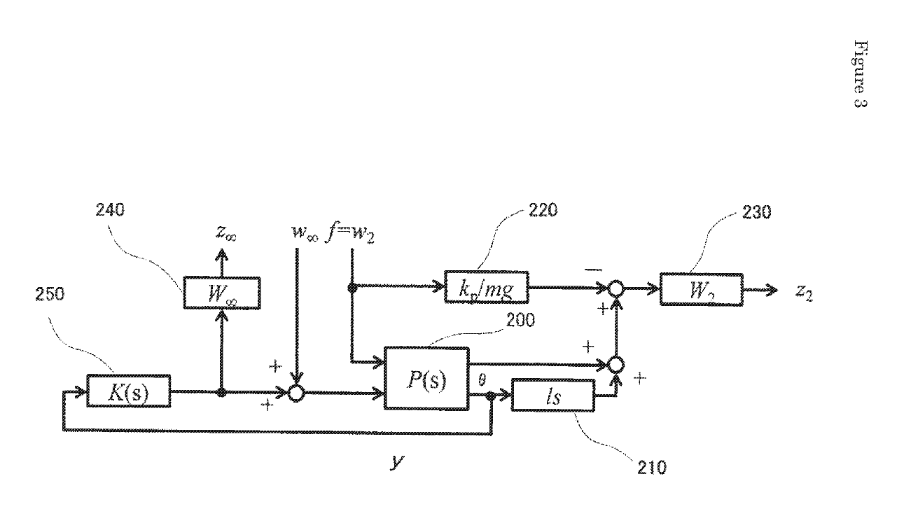

Next, a structure for deriving the mathematical model from the apparatus illustrated in FIG. 1 is described with reference to FIG. 2. In FIG. 2, the overhead crane cart 14 moves in the left-right direction. The suspender 16 is a rigid rod. The overhead crane cart 14 and the suspender 16 are connected to each other with the pin joint, while the suspender 16 and the container 32 are connected to each other with the rigid joint. A liquid surface 36 in the container 32 vibrates in a primary mode. This is because the high-order vibration of the liquid surface usually does not easily occur in the size range of the liquid tank to be transported by the overhead crane, and even if the high-order vibration occurred, the vibration would not be large. Note that even when the liquid surface 36 in the container 32 vibrates in the high-order mode or the suspender 16 and the container 32 are connected to each other with the pin joint instead of the rigid joint, the overhead crane cart 14 can be controlled to suppress the swing of the liquid tank 30 or the sloshing of the liquid surface 36 by performing the analysis and designing the control system in a similar way.

The mass of combination of the suspender 16 and the container 32 (also called “the rod-tank coupled system”) is and the length from the joint point between the suspender 16 and the overhead crane cart 14 to the center of gravity of the mass m₁ is l₁. Assuming the mass of the liquid 34 in the container 32 as m₂, the sloshing of the liquid 34 is modeled into a simple pendulum whose arm length from the center of gravity is 12 (also called “an equivalent pendulum”). The equivalent viscosity c is obtained in consideration of the viscosity of the liquid 34 itself and the friction between the liquid 34 and the wall surface of the container 32. The vibration model totaling the swing of the rod-tank coupled system and the sloshing of the liquid 34 is called the coupled system model.

The swing of the rod-tank coupled system from the joint point, i.e., the swing angle is θ₁, and the tilt angle of the equivalent pendulum is θ₂. When the overhead crane cart 14 travels at an acceleration \ddot{X}, the motion equation is expressed by Formula (1):

$$[ Expression 1 ]$$

$$\begin{matrix}{\ddot{θ}}_{1} = \frac{{m}_{2}^{2} {l}_{1} {l}_{2}^{2} - ( {m}_{1} + {m}_{2} ) {l}_{1} {l}_{2}}{{I}_{1} {I}_{2} - {m}_{2}^{2} {l}_{1}^{2} {l}_{2}^{2}} \ddot{x} - \frac{( {m}_{1} + {m}_{2} ) {gl}_{1} {l}_{2}}{{I}_{1} {I}_{2} - {m}_{2}^{2} {l}_{1}^{2} {l}_{2}^{2}} {θ}_{1} - \frac{{DI}_{2}}{{I}_{1} {I}_{2} - {m}_{2}^{2} {l}_{1}^{2} {l}_{2}^{2}} {\dot{θ}}_{1} + \frac{{m}_{2}^{2} {gl}_{1} {l}_{2}^{2}}{{I}_{1} {I}_{2} - {m}_{2}^{2} {l}_{1}^{2} {l}_{2}^{2}} {θ}_{2} + \frac{{m}_{2} {l}_{1} {l}_{2} c}{{I}_{1} {I}_{2} - {m}_{2}^{2} {l}_{1}^{2} {l}_{2}^{2}} {\dot{θ}}_{2} \\ {\ddot{θ}}_{2} = \frac{{m}_{2} ( {m}_{1} + {m}_{2} ) {l}_{1}^{2} {l}_{2} - {m}_{2} {l}_{2} {I}_{1}}{{I}_{1} {I}_{2} - {m}_{2}^{2} {l}_{1}^{2} {l}_{2}^{2}} \ddot{x} + \frac{{m}_{2} ( {m}_{1} + {m}_{2} ) {gl}_{1}^{2} {I}_{2}}{{I}_{1} {I}_{2} - {m}_{2}^{2} {l}_{1}^{2} {l}_{2}^{2}} {θ}_{1} + \frac{{m}_{2} {l}_{1} {l}_{2} D}{{I}_{1} {I}_{2} - {m}_{2}^{2} {l}_{1}^{2} {l}_{2}^{2}} {\dot{θ}}_{1} - \frac{{m}_{2} {gl}_{2} {l}_{1}}{{I}_{1} {I}_{2} - {m}_{2}^{2} {l}_{1}^{2} {l}_{2}^{2}} {θ}_{2} - \frac{{cI}_{1}}{{I}_{1} {I}_{2} - {m}_{2}^{2} {l}_{1}^{2} {l}_{2}^{2}} {\dot{θ}}_{2}\end{matrix} \} \qquad ( 1 )$$

where,
I₁=(m₁+m₂)lₗ²+i₁
I₂=m₂I₂²+i₂,
i₁: the moment of inertia around the center of gravity of the rod-tank coupled system
i₂: the moment of inertia around the center of gravity of the liquid 34
l₁: the distance to the center of gravity of the rod-tank coupled system
l₂: the length of the equivalent pendulum
m₁: the mass of the rod-tank coupled system
m₂: the mass of the liquid 34
c: the equivalent viscosity obtained in consideration of the viscosity of the liquid 34 itself and the friction between the liquid 34 and the wall surface of the container 32
D: the viscosity coefficient of the rotation supported part (the joint point between the suspender 16 and the overhead crane cart 14)
\ddot{X}:the traveling acceleration of the overhead crane cart 14.

FIG. 3 illustrates a generalized plant for controlling the structure for transporting the liquid tank by the overhead crane illustrated in FIG. 1 and FIG. 2. The design of the control system for the generalized plant illustrated in FIG. 3 is described. Here, the mixed H₂/H_{∞} control theory is employed. Here, the mixed H₂/H_{∞} control theory is the theory to stabilize the closed loop system for a generalized controllable object, and intended to design the linear time invariant controller for minimizing

$$\vert \vert \frac{{z}_{2}}{{w}_{2}} {\vert \vert}_{2}$$

under the restriction that

$$\vert \vert \frac{{z}_{∞}}{{w}_{∞}} {\vert \vert}_{∞} < 1$$

is satisfied. In the generalized plant, the influence of the equivalent pendulum on the rod-tank coupled system, i.e., the multiplicative error is covered with the frequency weight function W_{∞} to be described below; thus, the single mass point model is established.

The input manipulation amount W_{∞} from the paddle 110 and the external force W₂ to act on the container 32 are externally input. The control amount z₂ obtained by applying the frequency weight function W₂ to the displacement of the container 32 in the stationary state and the control amount z_{∞} obtained by applying the frequency weight function to the displacement of the container 32 relative to the input manipulation amount W_{∞} are used. Here, the external force w₂ is the force applied when, for example, an object collides with the container 32 or corresponds to wind power or the like. The external force W₂ is normally zero. P(s) 200 corresponds to the motion equation to be described below. In addition, is 210 is the function for converting the swing angle θ of the suspender 16 measured with the angular displacement meter 130 into the displacement of the container 32. In addition, kₚ/mg 220 is the function for converting the external force W₂ into the displacement of the container 32. Note that m represents the mass of the rod-tank coupled system, i.e., m₁ in Formula (1), and g corresponds to the gravitational acceleration. Moreover, W₂ 230 and W_{∞} 240 are the frequency weight functions and will be described below. K(s) 250 is the function for calculating the amount of correction of the input manipulation amount from the swing angle θ measured by the angular displacement meter 130, and is the controller of the control system. That is, the feedback control is executed based on the swing angle θ. K(s) 250 calculates the amount of correction of the velocity input value to the overhead crane cart 14 to control so as to reduce the swing of the container 32. Note that s represents the Laplace operator.

The motion equation of the nominal model P(s) 200 in FIG. 3 is represented by Formula (2):

$$[ Expression 2 ]$$

$$[ \begin{matrix}\dot{θ} \\ \ddot{θ} \\ \ddot{x}\end{matrix} ] = [ \begin{matrix}0 & 1 & 0 \\ - \frac{g}{l} & - \frac{D}{{ml}^{2}} & \frac{1}{Tl} \\ 0 & 0 & - \frac{1}{T}\end{matrix} ] [ \begin{matrix}θ \\ \dot{θ} \\ \dot{x}\end{matrix} ] + [ \begin{matrix}0 \\ \frac{1}{ml} \\ 0\end{matrix} ] f + [ \begin{matrix}0 \\ - \frac{1}{Tl} \\ \frac{1}{T}\end{matrix} ] u \qquad ( 2 )$$

where,
u: the velocity command value to the overhead crane cart
T: the time constant satisfying

u=Tx+\dot{x}
l: the distance to the center of gravity of the rod-tank coupled system, i.e.,
l₁ in Formula (1)
f: the external force.
The position x of the overhead crane cart is not important and is omitted in Formula (2).

Formula (2) is replaced like Formula (3):

[Expression 3]

\dot{x}ₚ=Aₚxₚ+Bₚ₁w+Bₚ₂u (2)

The output equation is Formula (4):

[Expression 4]

yₚ=Cₚxₚ (4).

Note that the following formulae are satisfied:

$$[ Expression 5 ]$$

$$\begin{matrix}w = {[ {W}_{∞} {w}_{2} ]}^{T} \\ [ Expression 6 ] & ( 5 ) \\ {B}_{p 1} = [ \begin{matrix}0 & 0 \\ - \frac{1}{Tl} & \frac{1}{ml} \\ \frac{1}{T} & 0\end{matrix} ] \\ [ Expression 7 ] & ( 6 ) \\ {C}_{p} = [ 1 \; 0 \; 0 ] . & ( 7 )\end{matrix}$$

In addition, the following formula is satisfied:

[Expression 8]

yₚ=y (8).

Note that y is the output variable vector.

The frequency weight function W_{∞} 240 of the generalized plant illustrated in FIG. 3 is designed so as to cover the multiplicative error between the nominal model and the coupled system model where the equivalent pendulum is added to the rod-tank coupled system. One example is represented by Formula (9). In this manner, since the frequency weight function W_{∞} 240 is designed to cover the multiplicative error, the control system with the high robustness can be designed.

$$[ Expression 9 ]$$

$${W}_{∞} = \frac{{s}^{2} + 8 s + 4}{{s}^{2} + 2 s + 213.2} \qquad ( 9 )$$

The frequency weight function W_{∞} 240 is represented by Formula (10) and Formula (11) as the state equation.

[Expression 10]

\dot{x}_{∞}=A_{∞}x_{∞}+B_{∞}u (10)

[Expression 11]

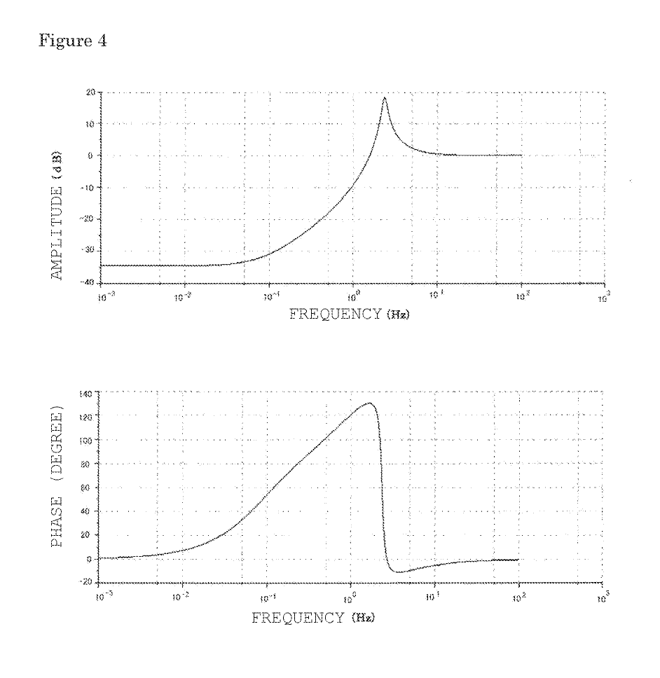

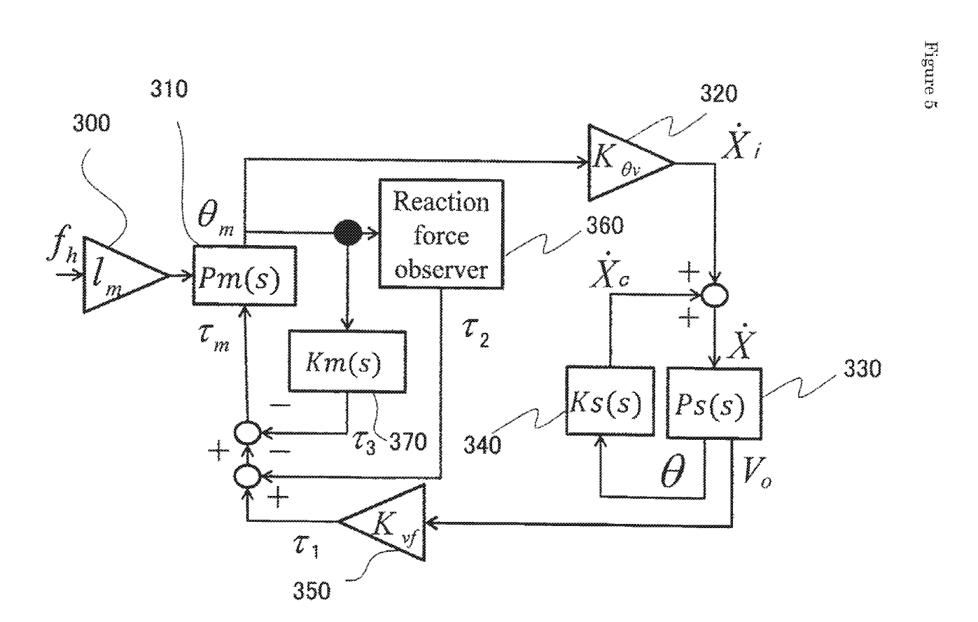

z_{∞}=C_{∞}x_{∞}+D_{∞}u (11)

where,
\dot{x}_{∞}: the state variable in H_{∞} and also the traveling velocity of the nominal model
z_{∞}: the control amount in H_{∞} control
x_{∞}: the state variable in H_{∞} control and also the position of the nominal model
u: the control input in H_{∞} control
A_{∞}, B_{∞}, C_{∞}, D_{∞}: the coefficient of the state equation in H_{∞} control. FIG. 4 shows one example of the Bode diagram of the frequency weight function W_{∞} 240 obtained by the numerical calculation.

The low pass filter or the integrator is used as the frequency weight function W₂ 230 of the generalized plant illustrated in FIG. 3 to make the quick convergence at low frequency. As one example, the low pass filter represented by Formula (12) and having a time constant of 0.2 is used.

$$[ Expression 12 ]$$

$${W}_{2} = \frac{1}{0.2 s + 1} \qquad ( 12 )$$

The frequency weight function W₂ 230 is represented by Formula (13) and Formula (14) as the state equation.

[Expression 13]

\dot{x}₂−A₂x₂+B₂u₂ (13)

[Expression 14]

z₂=C₂x₂ (14)
where,
\dot{x}₂: the state variable in H₂ control and the traveling velocity of the nominal model
z₂: the control amount in H₂ control
A₂, B₂, C₂: the coefficients of the state equation in H₂ control.

[Expression 15]

u₂=[o l 1]xₚ−└o kₚ/(mg)┘w (15)

The state variable x is represented by Formula (16).

[Expression 16]

x=[xₚ^{T}x_{∞}^{T}x₂^{T}]^{T} (16)

Integrating the state equations described above provides the following Formulae (17) to (20):

$$[ Expression 17 ]$$

$$\begin{matrix}\dot{x} = [ \begin{matrix}{A}_{p} & 0 & 0 \\ 0 & {A}_{∞} & 0 \\ {B}_{2} [ 0 l 1 ] & 0 & A - 2\end{matrix} ] x + [ \begin{matrix}{B}_{p 1} \\ 0 \\ {B}_{2} [ 0 - {k}_{p} \text{/} ( mg ) ]\end{matrix} ] w + [ \begin{matrix}{B}_{p 2} \\ {B}_{∞} \\ 0\end{matrix} ] u \\ [ Expression 18 ] & ( 17 ) \\ {z}_{∞} = [ 0 {C}_{∞} 0 ] x + {D}_{∞} u \\ [ Expression 19 ] & ( 18 ) \\ {z}_{2} = [ 0 \; 0 {C}_{2} ] x \\ [ Expression 20 ] & ( 19 ) \\ y = [ {C}_{p} 0 \; 0 ] x & ( 20 )\end{matrix}$$

In accordance with Formulae (17) to (20) above, the controller K(S) 250 is calculated by the numerical analysis so that

$$\vert \vert \frac{{z}_{∞}}{{w}_{∞}} {\vert \vert}_{∞}$$

satisfies 1 or less and

$$\vert \vert \frac{{z}_{2}}{{w}_{2}} {\vert \vert}_{2}$$

becomes as small as possible. Here,

$$\vert \vert \frac{{z}_{∞}}{{w}_{∞}} {\vert \vert}_{∞}$$

is the upper limit value of z_{∞}/w_{∞} in the entire regions, and setting the value to 1 or less means that the output does not exceed the input w_{∞}.

$$\vert \vert \frac{{z}_{2}}{{w}_{2}} {\vert \vert}_{2}$$

is the square root of the square area of z²/W₂, and when

$$\vert \vert \frac{{z}_{2}}{{w}_{2}} {\vert \vert}_{2}$$

is small, z₂ becomes 0 (zero) quickly in response to the input of W₂.

The numerical analysis can be executed using, for example, the commercial software such as MATLAB® or Scilab®. According to the present control system, the control can be executed to make

$$\vert \vert \frac{{z}_{∞}}{{w}_{∞}} {\vert \vert}_{∞}$$

1 or less relative to the input manipulation amount W_{∞} from the paddle 110, and therefore the displacement of the container 32, i.e., the swing can be suppressed. In addition, since the control system is designed so that

$$\vert \vert \frac{{z}_{2}}{{w}_{2}} {\vert \vert}_{2}$$

becomes smaller quickly, the swing of the container 32 can be reduced quickly. Therefore, the swing of the liquid tank 30 and the sloshing of the liquid 34 in the liquid tank 30 can be prevented, and the overhead crane cart 14 can be moved fast to the target area in accordance with the velocity command value from the operator.

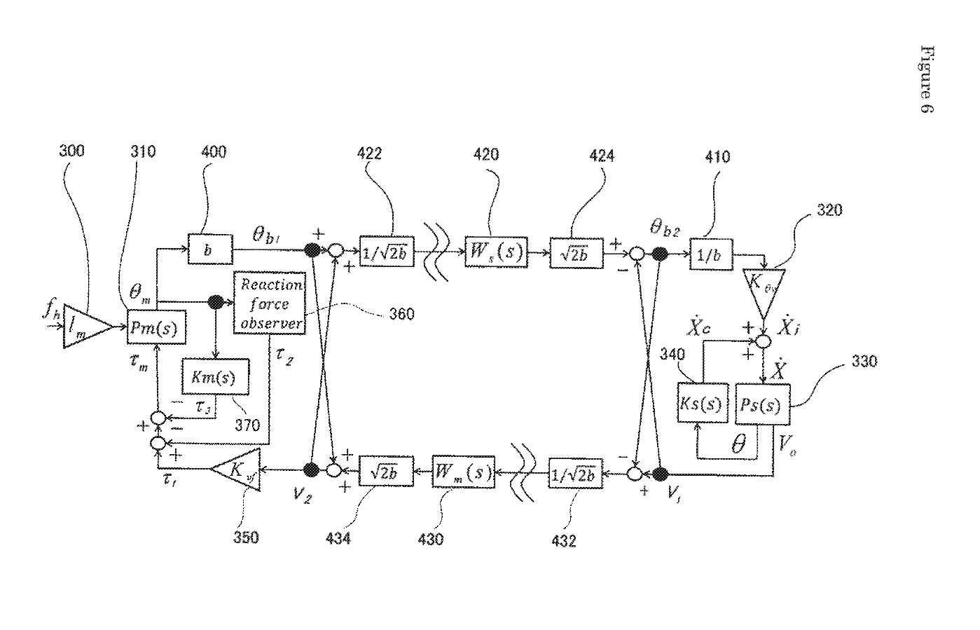

Next, with reference to the block diagram in FIG. 5, description is made of the method of transporting the liquid tank 30 while preventing the swing of the liquid tank 30 with the use of the control system as the device illustrated in FIG. 1. First, the operator tilts the paddle 110 to set the desired velocity command value. That is, the force fₕ to apply a predetermined torque is applied to the paddle 110. Here, the operator attempts to input the velocity command value to achieve the desired transport time. Note that lₘ 300 corresponds to the paddle 110. Then, the manipulation angle θₘ of the paddle 110 is calculated and output in Pm(S) 310 corresponding to the input device 100. Then,
the velocity input value \dot{X}ᵢ of the overhead crane cart 14 in accordance with the manipulation angle θₘ of the paddle 110 is calculated in K_{θ}_{ᵥ} 320. In Ps(S) 330 corresponding to the overhead crane 10,
the velocity value \dot{X}obtained by totaling
the velocity input value \dot{X}_{i and}
the velocity control value \dot{X}_{c} to be described below is input and the overhead crane cart 14 is operated at
a velocity \dot{X}.
The swing angle θ of the suspender 16 hanging down from the overhead crane cart 14 is measured with the angular displacement meter 130, and sent to a controller Ks(S) 340. In Ks(S) 340,
the velocity control value \dot{X}_{c} to reduce the swing of the container 32 as described above is calculated and output. Thus, as described above, the overhead crane cart 14 is operated at such
a velocity \dot{X} that the swing of the liquid tank 30 is reduced.

Based on the measured swing angle θ of the suspender 16, the load velocity V₀ corresponding to the velocity of the liquid tank 30 relative to the overhead crane cart 14 is output from Ps(S) 330. In K_{vf} 350, the torque τ₁ for tilting the paddle 110 in proportion to the load velocity V₀ is calculated. That is, the value obtained by multiplying the torque that specifies the load velocity value V₀ with the paddle 110 by a predetermined coefficient and inverting the direction (i.e., the positive and negative directions) corresponds to the torque τ₁. Based on the manipulation angle θₘ output from the Pm(S) 310, a reaction force observer (Reaction force observer) 360 estimates the moment τ₂ added to the paddle 110 instead of the force sensor that measures the moment. In Km(S) 370, based on the resistance relative to the change in the manipulation angle θₘ of the paddle 110, i.e., the friction relative to the change in angular velocity of the paddle 110, the torque τ₃ generated by the friction is estimated. This torque τ₃ reduces the resistance when the paddle 110 is manipulated, mitigates the force required for the manipulation. The torques τ₁, τ₂, and τ₃ from K_{vf} 350, the reaction force observer 360, and the Km(S) 370 are integrated (τ₂ and τ₃ are subtracted from τ₁) and the resulting torque τₘ is input to the Pm(S) 310. Therefore, by recognizing the force or the torque τₘ through the paddle 110, the operator can know whether to accelerate or decelerate in order to reduce the swing of the liquid tank 30 and know the required amount of the acceleration or deceleration as the force from the paddle 110. That is, whether to accelerate or decelerate can be determined by directly sensing from the paddle 110 instead of by observing the motion of the overhead crane 10 or the liquid tank 30 with the monitor.

In this manner, according to this method, the overhead crane cart 14 can be controlled to prevent the overflow of the liquid 34 by suppressing the swing of the liquid tank 30. Thus, the liquid tank 30 can be transported to the target area fast. In addition, the operation of the overhead crane 10 to reduce the swing of the liquid tank 30 is conveyed to the operator directly from the input device 100; thus, even if the operator is not an expert, he or she can conduct the operation while surely suppressing the swing of the liquid tank 30.

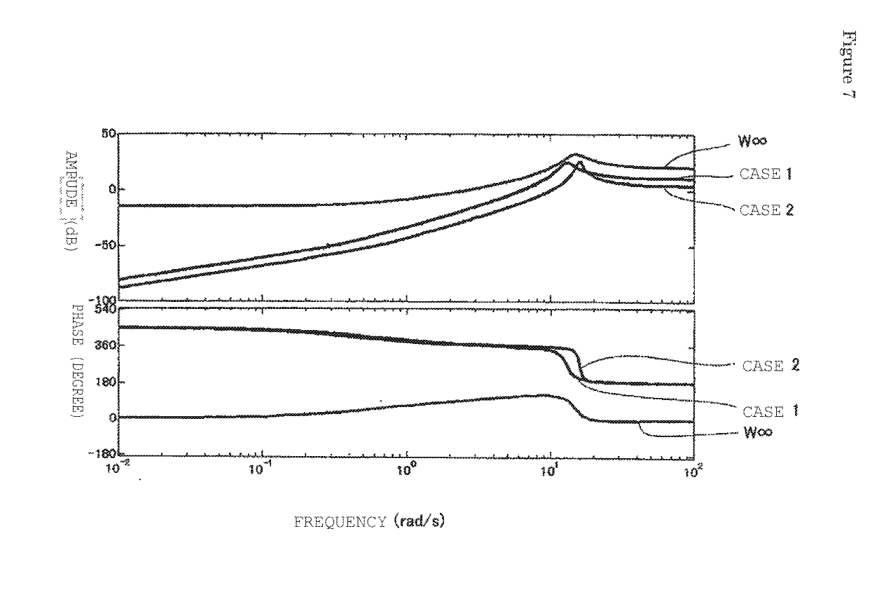

Next, with reference to the block diagram illustrated in FIG. 6, description is made of the case in which the overhead crane 10 and the input device 100 are placed far from each other. In the block diagram illustrated in FIG. 6, the control is executed basically in the same manner as that in the block diagram illustrated in FIG. 5. However, since the overhead crane 10 and the liquid tank 30 are placed far from the input device 100, the communication delay therebetween is not negligible. In FIG. 6, the communication between the overhead crane 10 and the input device 100 is expressed by Ws(S) 420 and Wm(S) 430. The communication herein referred to may be either the communication via the dedicated channel or the public channel such as the Ethernet, or the wireless channel. Since the communication distance is long, the transmission signal is preferably amplified in b 400 and the received signal is preferably attenuated in 1/b 410 to avoid the mixing of noises. Note that in FIG. 6, the amplifier b 400 and the attenuator 1/b 410 are illustrated on the front side and the back side of the Ws(S) 420 but the signal may be amplified/attenuated on the front side and the back side of the Wm(S) 430. Alternatively, the amplification/attenuation may be omitted. In addition, the symbol b including the symbol b in 1/\sqrt{2b}422, \sqrt{2b}424, 1/\sqrt{2b}432, and \sqrt{2b}434 are the arbitrary positive numbers called the characteristic impedance.

In regard to the stability of the control system with the communication delay, the scattering conversion is employed because it is known that this conversion stabilizes the control system. Even when the overhead crane 10 and the input device 100 are placed far from each other, using the scattering conversion makes it possible to transport the liquid tank 30 by the overhead crane 10 while suppressing the swing of the liquid tank 30 and preventing the overflow of the liquid 34. In addition, the information on the acceleration and deceleration of the overhead crane 10 to reduce the swing of the liquid tank 30 can be directly and properly conveyed from the input device 100 to the operator.

### EXAMPLE 1

In order to check the effectiveness of the control system according to the present invention, the swing of the liquid tank and the sloshing of the liquid surface during the transport of the liquid tank by the overhead crane were measured using the experiment apparatus. The overhead crane travels in one direction. Two metal rods hang down from the overhead crane with the pin joint in the direction orthogonal to the traveling direction. The liquid tank was hung by the two rods and each rod and the liquid tank were connected with the rigid joint. As the liquid tank, an acrylic rectangular parallelepiped container with a width of 200 mm, a length of 200 mm, and a height of 300 mm was used. Water was poured into the liquid tank

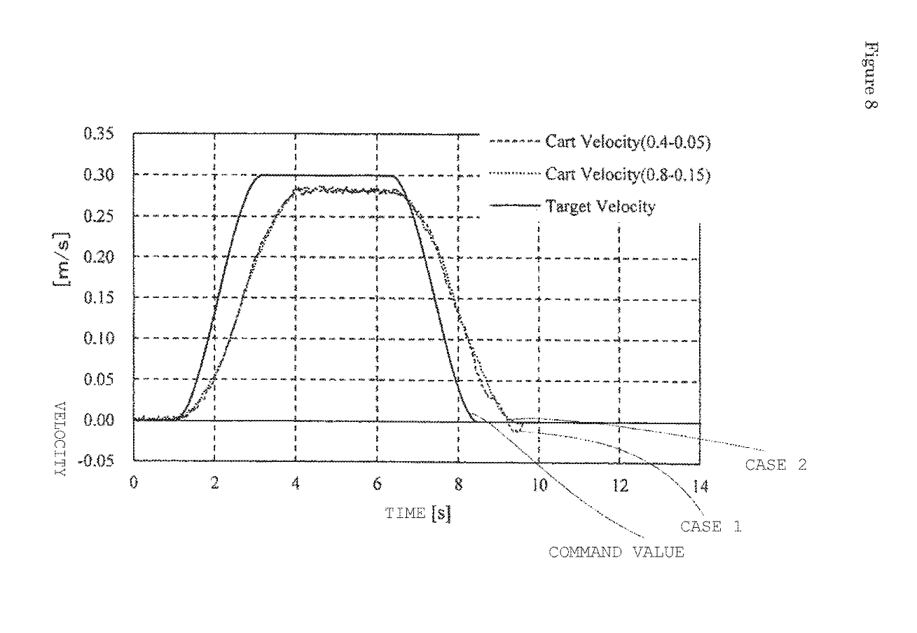

The experiments were carried out for a case 1 in which the rod has a length of 0.4 m and the liquid has a depth of 0.05 m and a case 2 in which the rod has a length of 0.8 m and the liquid has a depth of 0.15 m. The robustness of the control system was also checked. The frequency weight function W_{∞} of the control system used in the experiments was as shown in FIG. 7 so that the multiplicative errors in the case 1 and the case 2 were covered. The overhead crane cart was traveled and the swing of the liquid tank, i.e., the swing angle of the rod was measured and the sloshing of the liquid surface was measured at the height of the sloshing on the wall surface in the traveling direction of the liquid tank. Specifically, the displacement of the position of the suspender suspended from the support point by a predetermined length was measured with the laser sensor (VG-035, manufactured by KEYENCE Corporation, Japan) attached to the overhead crane cart, and the measured displacement was used as the swing angle. With the ultrasonic sensor (E4C-DS30, manufactured by OMRON Corporation, Japan) attached at the position 10 mm away from the wall surface of the liquid tank, the position of the liquid surface was measured and the difference from the height when the liquid tank was stationary was used as the sloshing of the liquid surface.

The velocity of the overhead crane cart was changed along the trapezoidal shape as illustrated in FIG. 8. A little delay was observed relative to the velocity command value but the overhead crane cart moved in the similar manner in both the case 1 and the case 2.

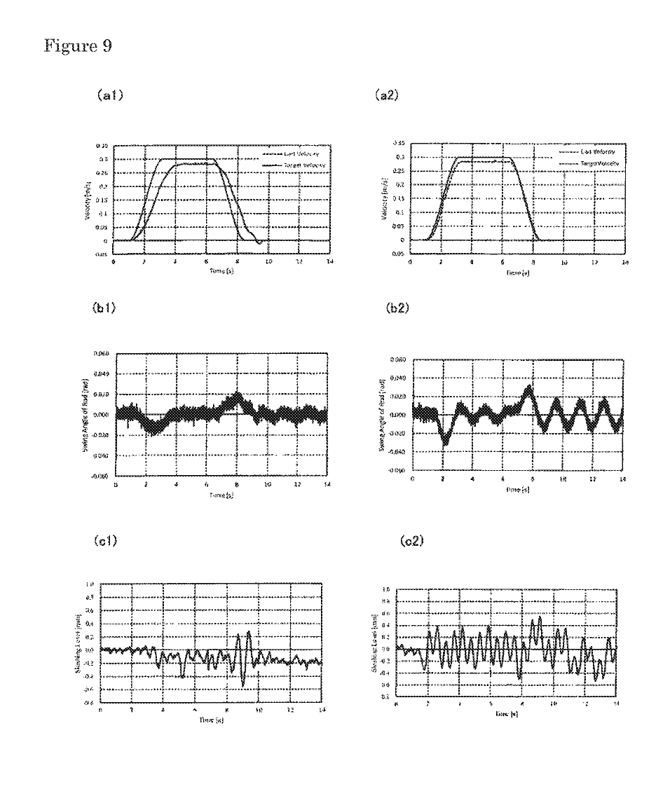

FIG. 9 show the results of measurements on the case 1, i.e., the case in which the rod has a length of 0.4 m and the liquid has a depth of 0.05 m. FIG. 9(a) show the velocity of the overhead crane cart, FIG. 9(b) show the swing angle of the liquid tank, and FIG. 9(c) show the sloshing of the liquid surface. The left side of FIG. 9, i.e., (a1), (b1), and (c1) show the case with the control system and the right side of FIG. 9, i.e., (a2), (b2), and (c2) show the case without the control system. As compared to the case without the control, using the control system according to the present example can suppress the maximum value of the swing of the liquid tank from 0.03 rad (1.7°) to 0.02 rad (1.1°) and reduces the maximum value of the sloshing of the liquid surface from 0.55 mm to 0.25 mm.

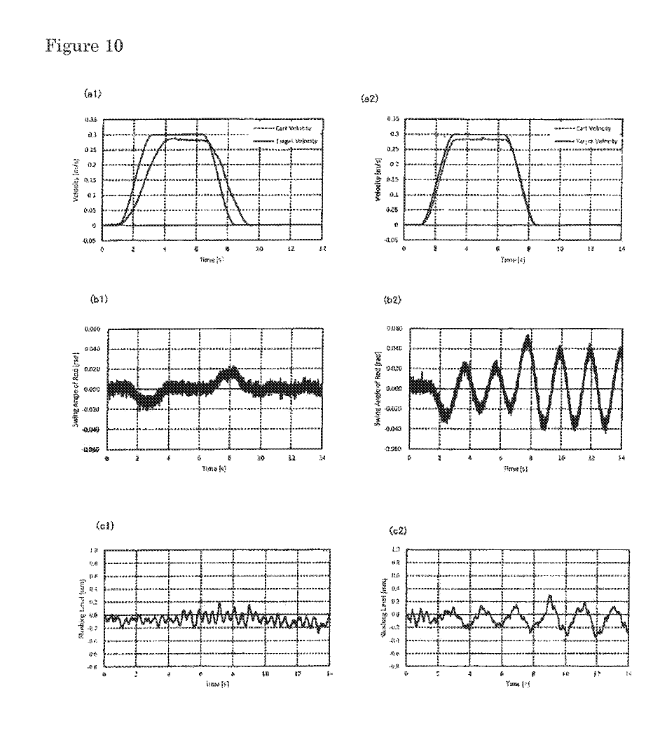

FIG. 10 show the results of measurements on the case 2, i.e., the case in which the rod has a length of 0.8 m and the liquid has a depth of 0.15 m. FIG. 10(a) show the velocity of the overhead crane cart, FIG. 10(b) show the swing angle of the liquid tank, and FIG. 10(c) show the sloshing of the liquid surface. The left side of FIG. 10, i.e., (a1), (b1), and (c1) show the case with the control system and the right side of FIG. 10, i.e., (a2), (b2), and (c2) show the case without the control system. As compared to the case in which the control is not executed, using the control system according to the present example can suppress the maximum value of the swing of the liquid tank from 0.055 rad (3.2°) to 0.02 rad (1.1°) and reduces the maximum value of the sloshing of the liquid surface from 0.3 mm to 0.2 mm. When the control system according to the present example is used, both the swing angle and the sloshing of the liquid surface in the cases 1 and 2 can be suppressed to be low and the robustness of the control system according to the present example was demonstrated.

### EXAMPLE 2

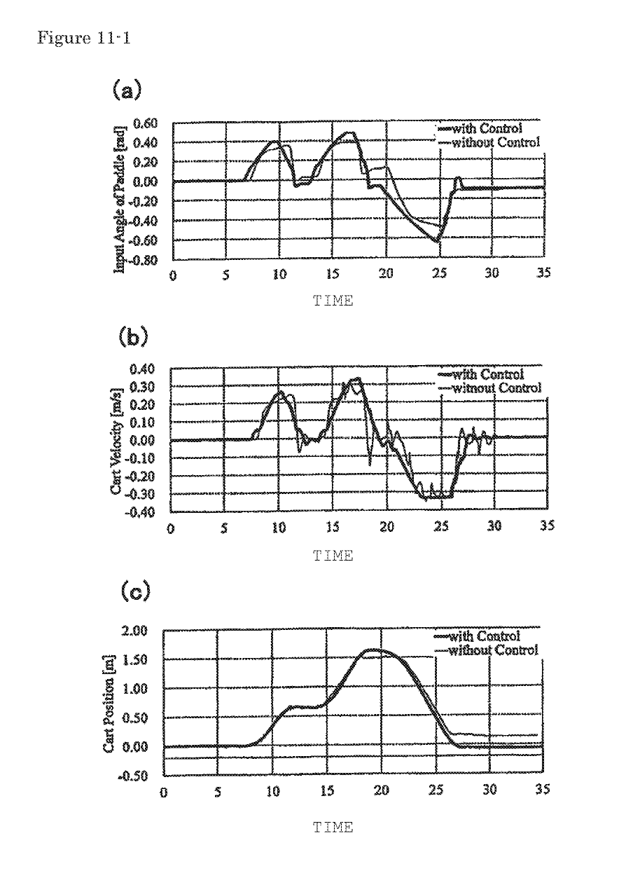

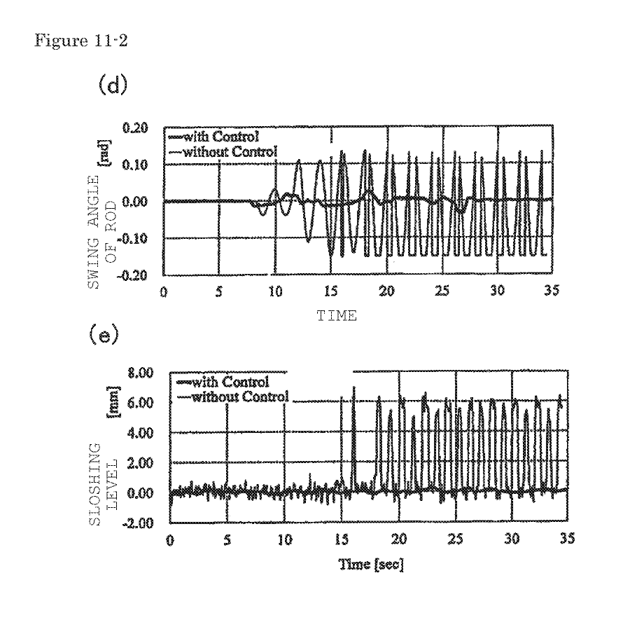

To check the effectiveness of the control system according to the present invention through the remote operation, the experiments similar to those of Example 1 were conducted by generating the communication delay for 50 ms between the input device and the overhead crane. Note that the acrylic container with a width of 200 mm, a length of 200 mm, and a height of 300 mm was used as a liquid tank, the rod length was set to 0.6 m, and the liquid depth was set to 0.15 m. The control system, which is similar to that of Example 1, employed the scattering conversion. The operator manipulated the paddle of the input device so that the overhead crane cart moved to the position about 0.6 m, stopped there once, and then moved again to the position 1.6 m. FIG. 11 show the results of when the control system according to the present Example was used and not used.

FIG. 11(a) shows the angle of the paddle of the input device. It has been demonstrated that the control system according to this example smoothens the paddle angle and facilitates the manipulation because the operator manipulates the system while recognizing the deceleration/acceleration information to reduce the swing of the liquid tank through the paddle with the force of the paddle (torque). FIG. 11(b) shows the traveling velocity of the overhead crane and FIG. 11(c) shows the position of the overhead crane cart. By using the control system according to the present example, it is understood that the traveling velocity is stable.

FIG. 11(d) shows the swing angle and FIG. 11(e) shows the sloshing of the liquid surface. By using the control system according to the present example, the swing angle and the sloshing of the liquid surface were remarkably reduced. Thus the effect of the present invention has been demonstrated.

As described above, by using the control system according to the present invention or the transport method based on the control system, the swing of the liquid tank to be transported by the overhead crane can be suppressed and the sloshing of the liquid surface can also be suppressed. In addition, inputting the velocity command value by manipulating the paddle angle of the input device and generating the force (torque) in the paddle so as to suppress the swing of the liquid tank through the control system facilitate the manipulation of the operator. Moreover, even if the overhead crane and the input device are placed far from each other to such a degree that the communication delay is not negligible, the stable control can be executed.

The control over the transport of the liquid tank by the overhead crane has been described so far, but the technical idea of the present invention is widely applicable to the general control of the double mass point.

When the present invention is applied to the transport of the molten metal in the foundry, the swing of the ladle and the sloshing of the molten metal in the ladle can be suppressed. Thus, the risk caused by the overflow of the molten metal can be reduced, the deterioration in product due to the involution of slag can be prevented, and moreover the molten metal can be transported efficiently. Even a non-expert can manipulate the transport by the overhead crane for sure. Even the operator away from the overhead crane can securely conduct the operation, and the safety is therefore high.

The reference signs used in the present specification and the drawings are as follows:
10 Overhead crane
12 Rail
14 Overhead crane cart
16 Suspender
30 Liquid tank
32 Container
34 Liquid
36 Liquid surface
100 Input device
110 Paddle
120 Control device
130 Angular displacement meter
c Equivalent viscosity
l₁ Length from the joint point to the center of gravity
l₂ Arm length when the sloshing of the liquid is modeled into the simple pendulum
m₁ Mass of suspender and container
m₂ Mass of liquid
W₂, W_{∞} Frequency weight function
W₂ Disturbance
w_{z} Manipulation amount
z₂, z_{∞} Control amount

1. A system for controlling transport of a liquid tank by an overhead crane, wherein:
swing of a liquid tank and a suspender that suspends the liquid tank from an overhead crane cart, and sloshing of liquid in the liquid tank are modeled into a coupled system model;
the system is designed based on a mixed H₂/H_{∞} control method in which feedback control is executed using a swing angle of the suspender, a traveling command value of the overhead crane cart and an external force acting on the liquid tank are external inputs, and a difference between a position of the overhead crane cart and a position of the liquid tank is a control amount, wherein an integrator or a low pass filter is used as a frequency weight function of H₂ control, and wherein a frequency weight function of H_{∞} control is designed to cover a multiplicative error between the coupled system model and a nominal model in which the sloshing of the liquid in the liquid tank is not taken into consideration; and
the overhead crane cart is controlled so as to suppress the swing of the liquid tank when the liquid tank is transported by the overhead crane.

2. The system for controlling the transport of claim 1, the system being designed to control a primary vibration mode of the liquid in the liquid tank.

3. The system for controlling the transport of claim 2, wherein:
the traveling command value of the overhead crane cart is a velocity command value of the overhead crane cart and is input by manipulating an angle of a paddle; and
a force to change the angle is generated in the paddle on the basis of the swing of the liquid tank.

4. The system for controlling the transport of any one of claim 3, wherein a delay in signal transmission between the overhead crane and the paddle is processed by scattering conversion.

5. A method for transporting a liquid tank by an overhead crane using the system for controlling the transport of claim 1.

6. The method of claim 5, wherein the liquid tank is a ladle which contains molten metal.

7. A method for transporting a liquid tank by an overhead crane using the system for controlling the transport of claim 2.

8. The method of claim 7, wherein the liquid tank is a ladle which contains molten metal.

9. A method for transporting a liquid tank by an overhead crane using the system for controlling the transport of claim 3.

10. The method of claim 9, wherein the liquid tank is a ladle which contains molten metal.

11. A method for transporting a liquid tank by an overhead crane using the system for controlling the transport of claim 4.

12. The method of claim 11, wherein the liquid tank is a ladle which contains molten metal.
